(19) United States
(12) Patent Application Publication
(10) Pub. No.: US 2026/0220881 A1
(43) Pub. Date: Jul. 30, 2026

(54) GENERATING A RE-ILLUMINATED RECONSTRUCTION OF AN OBJECT

(71) Applicant: Adobe Inc., San Jose, CA (US)

(72) Inventors: Tianyuan Zhang, Cambridge, MA (US); Zhengfei Kuang, Mountain View, CA (US); Zexiang Xu, San Jose, CA (US); Yiwei Hu, New Haven, CT (US); Sai Bi, San Jose, CA (US); Miloš Hašan, Lafayette, CA (US); Kalyan Krishna Sunkavalli, San Jose, CA (US); Kai Zhang, San Jose, CA (US); He Zhang, Santa Clara, CA (US); Hao Tan, San Jose, CA (US); Haian Jin, San Jose, CA (US); Fujun Luan, Sunnyvale, CA (US)

(73) Assignee: Adobe Inc., San Jose, CA (US)

(21) Appl. No.: 19/041,371

(22) Filed: Jan. 30, 2025

(51) Int. Cl. G06T 15/50; G06T 7/60; G06T 15/04

(52) U.S. Cl. CPC G06T 15/506; G06T 7/60; G06T 15/04; G06T 2207/20081

(57) ABSTRACT

In implementation of techniques for generating a re-illuminated reconstruction of an object, a computing device implements a reconstruction system to receive digital images depicting an object from different angles and a selection of an illumination direction for virtually illuminating the object. The reconstruction system determines a geometry of the object using a machine learning model based on the digital images. Based on the geometry of the object, the reconstruction system determines illumination parameters corresponding to the illumination direction. The reconstruction system renders a reconstructed virtual object that is a virtual representation of the object based on the geometry and illuminated based on the illumination parameters.

### BACKGROUND

A three-dimensional Gaussian is a representation of a mathematical function that describes how data points are distributed in a three-dimensional space. The data points of the three-dimensional Gaussian represent edges, faces, corners, and curves of three-dimensional objects. For example, three-dimensional Gaussians are used to render three-dimensional objects for various applications, including video games, virtual reality, alternate reality, computer-aided design, and animation. However, rendering three-dimensional Gaussians results in visual inaccuracies, errors, computational inefficiencies, and increased power consumption in real world scenarios.

### SUMMARY

Techniques and systems for generating a re-illuminated reconstruction of an object are described. In an example, a reconstruction system receives digital images depicting an object from different angles and a selection of an illumination direction for virtually illuminating the object. For instance, the selection of the illumination direction is indicated by an environment map specifying a type of illumination for virtually illuminating the object.

The reconstruction system determines a geometry of the object using a machine learning model based on the digital images. In some examples, the machine learning model includes a first transformer model trained on prior virtual object reconstructions to reconstruct the geometry of the object.

The reconstruction system also determines illumination parameters corresponding to the illumination direction based on the geometry of the object. In some examples, determining the illumination parameters is performed using a second transformer model configured to denoise illuminated views of the reconstructed virtual object. The first transformer model and the second transformer model are trained on images of objects illuminated from multiple known directions.

Based on the geometry and illuminated based on the illumination parameters, the reconstruction system renders a reconstructed virtual object that is a virtual representation of the object. The reconstructed virtual object, for instance, is a three-dimensional Gaussian configured for positioning in a virtual three-dimensional environment.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures. Entities represented in the figures are indicative of one or more entities and thus reference is made interchangeably to single or plural forms of the entities in the discussion.

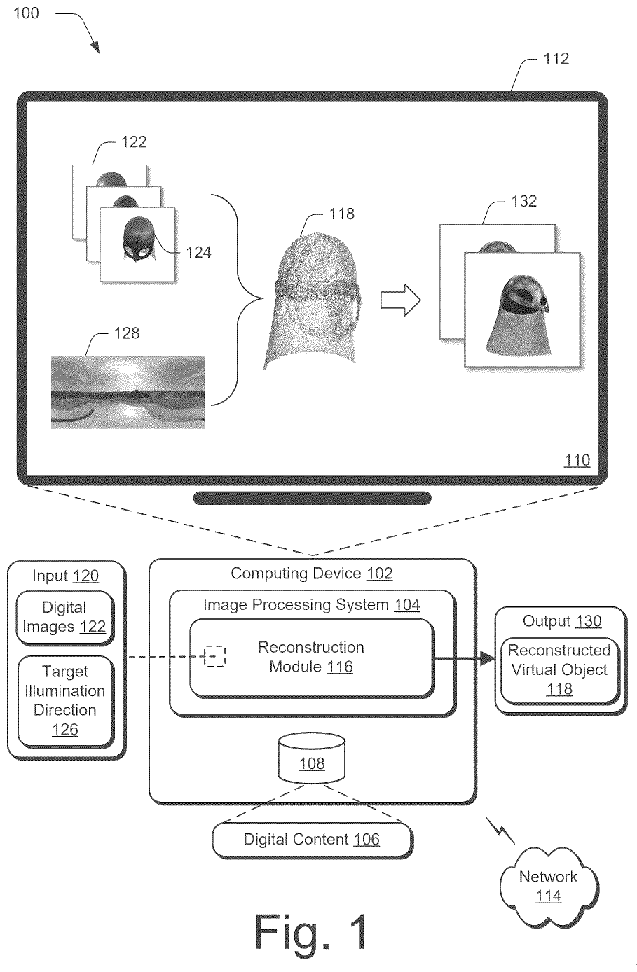

FIG. 1 is an illustration of a digital medium environment in an example implementation that is operable to employ techniques and systems for generating a re-illuminated reconstruction of an object as described herein.

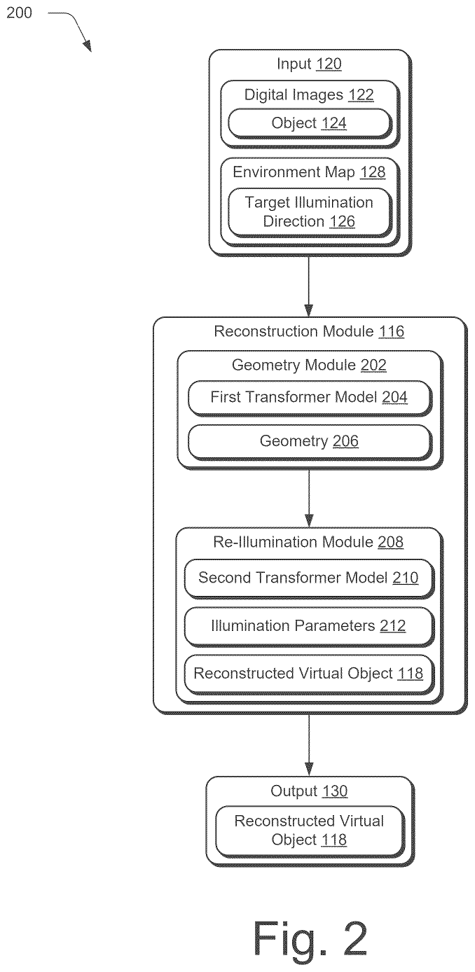

FIG. 2 depicts a system in an example implementation showing operation of a reconstruction module for generating a re-illuminated reconstruction of an object.

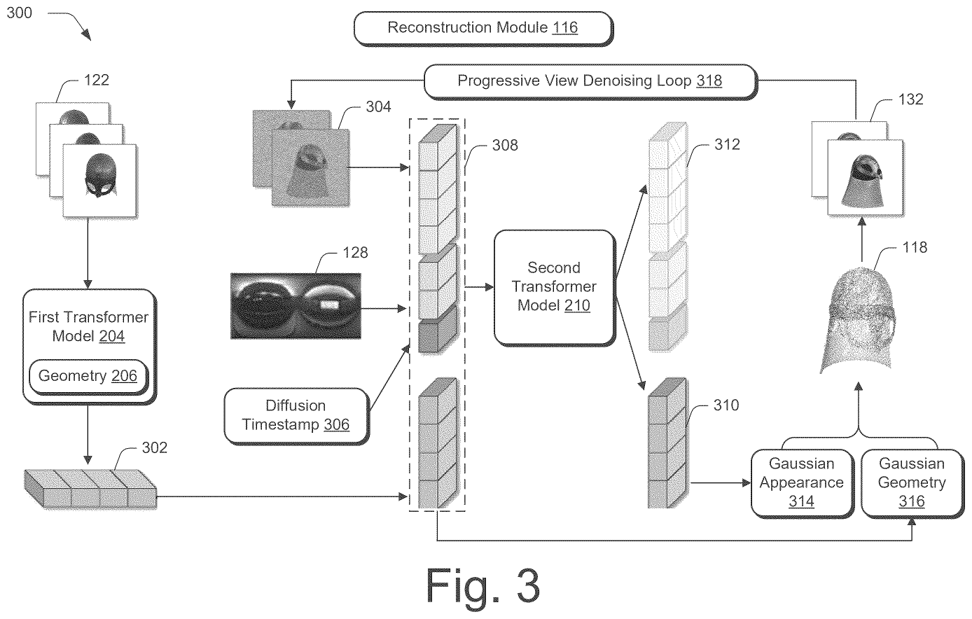

FIG. 3 depicts an example of an architecture including a first transformer model and a second transformer model of the reconstruction module.

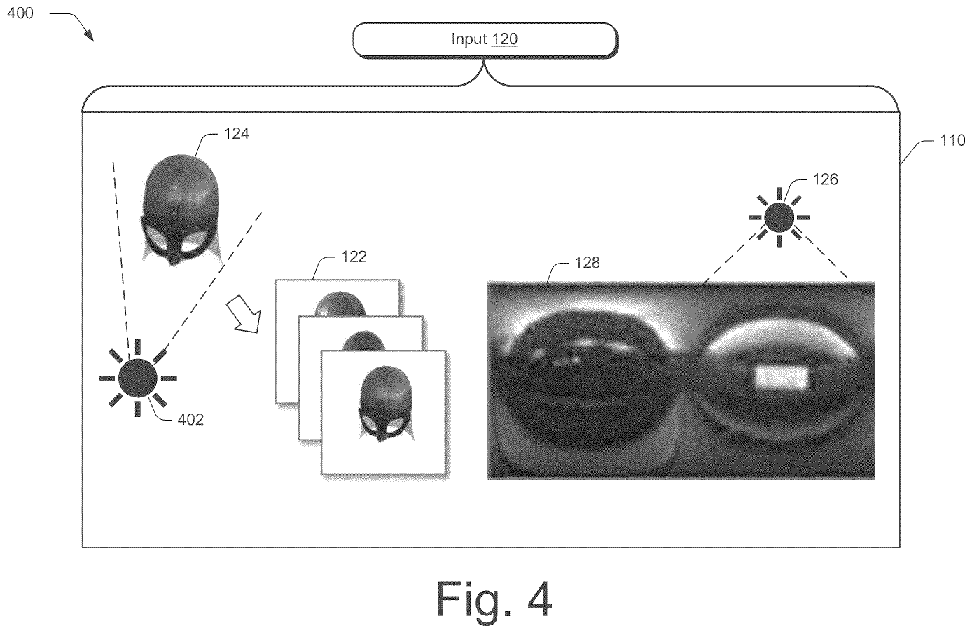

FIG. 4 depicts an example of receiving an input including digital images.

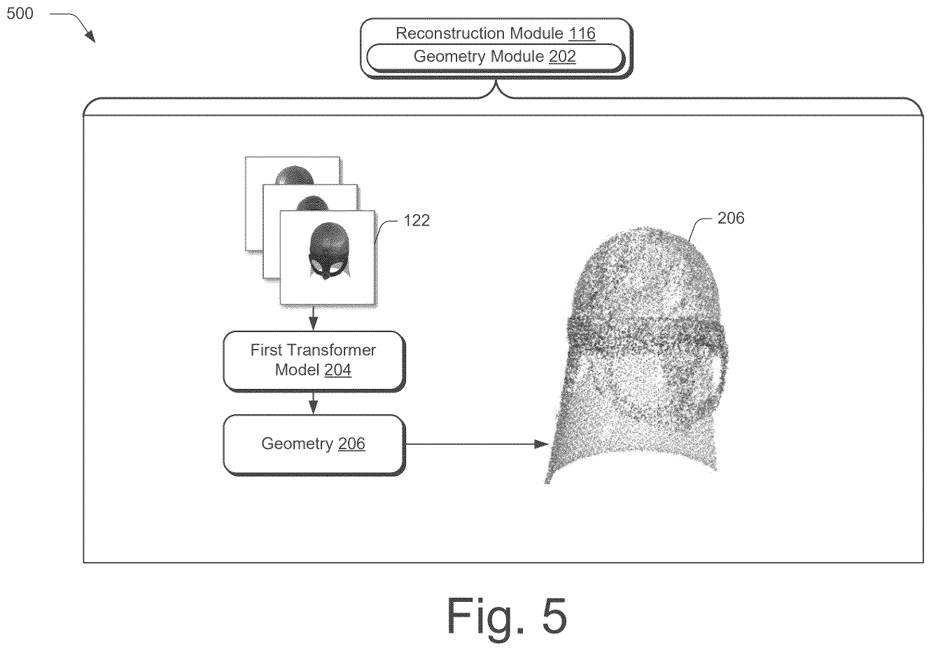

FIG. 5 depicts an example of determining a geometry based on the digital images.

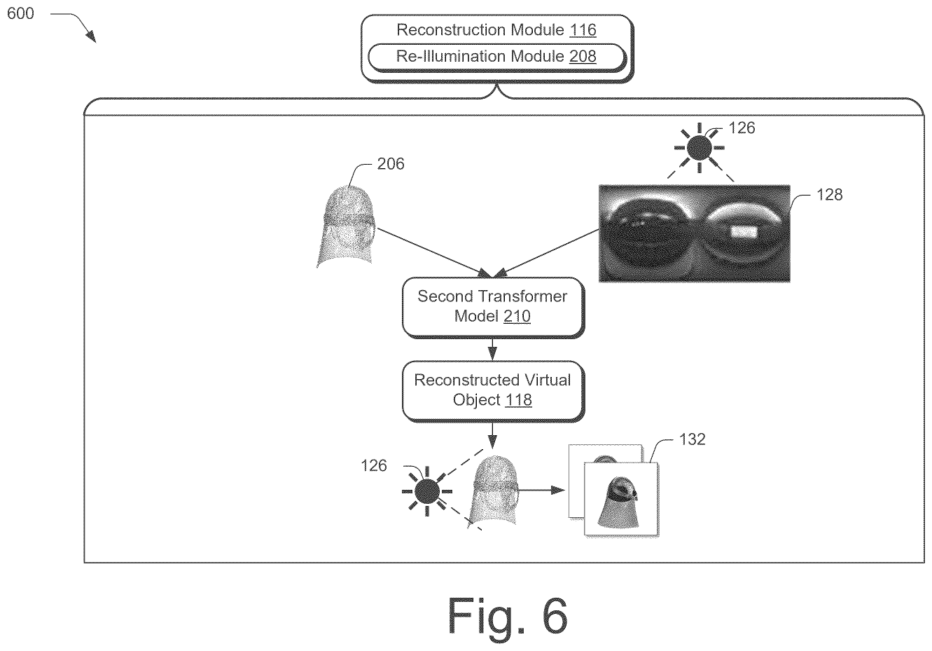

FIG. 6 depicts an example of determining illumination parameters for generating the re-illuminated reconstruction of the object.

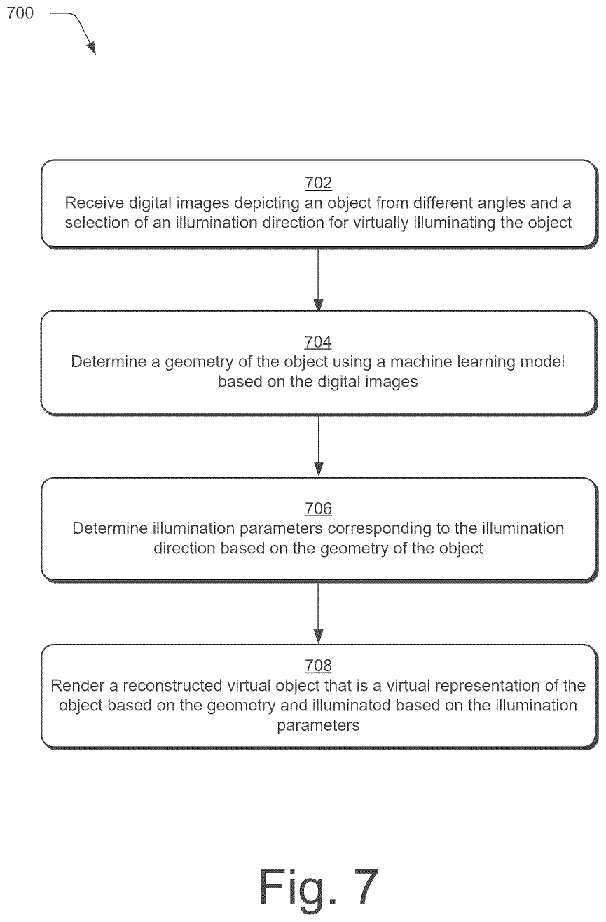

FIG. 7 depicts a procedure in an example implementation of generating a re-illuminated reconstruction of an object.

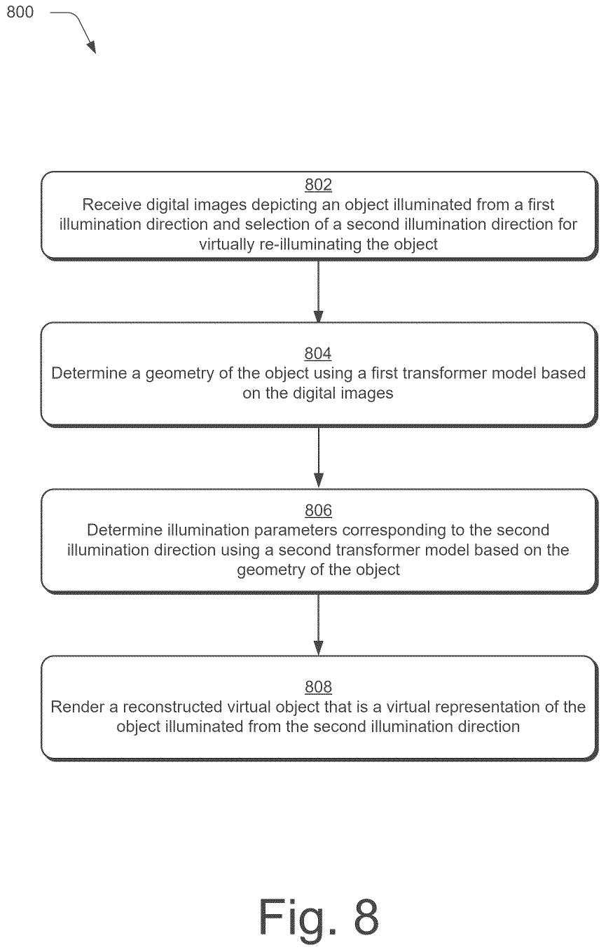

FIG. 8 depicts a procedure in an additional example implementation of generating a re-illuminated reconstruction of an object.

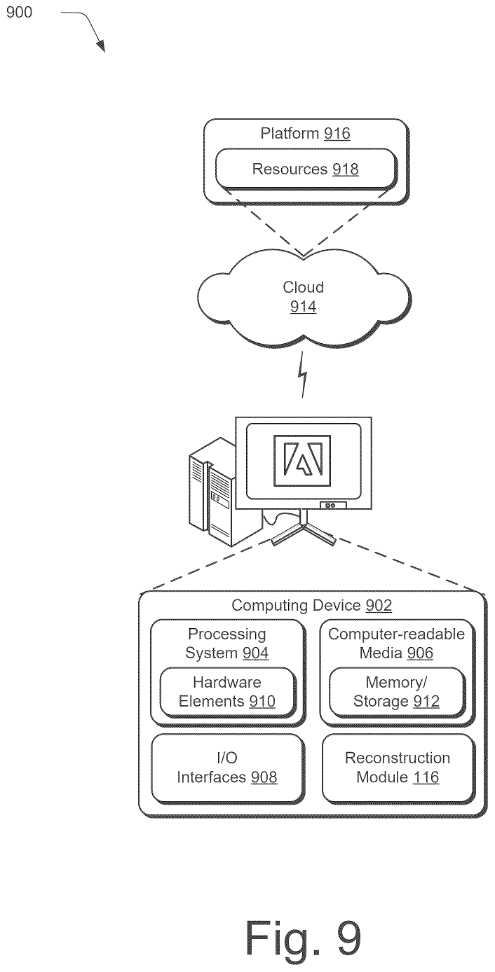

FIG. 9 illustrates an example system including various components of an example device that can be implemented as any type of computing device as described and/or utilized with reference to FIGS. 1-8 to implement embodiments of the techniques described herein.

### DETAILED DESCRIPTION

### Overview

Objects are depicted in virtual three-dimensional environments for a variety of applications, including video games, virtual reality, alternate reality, computer-aided design, and animation. Some applications involve generating virtual versions of real-life objects for incorporation into a virtual three-dimensional environment. For instance, multiple two-dimensional images depicting different views of an object are captured and are stitched together or processed to form a three-dimensional virtual version of the object.

However, conventional virtual object generation techniques involve hundreds of input images depicting an object and take hours to render a virtual object based on the input images. For example, the conventional virtual object generation techniques use an optimization framework that iteratively optimizes parameters for the virtual object, which takes hours to compute because the optimization framework is not trained on prior object reconstructions. Additionally, because the optimization framework involves hundreds of input images for different views, use cases for the optimization framework are limited and are not applicable to re-illuminating virtual objects, as the optimization framework is not configured for different lighting conditions.

Techniques and systems are described for generating a re-illuminated reconstruction of an object that overcomes these limitations. For instance, two transformer models are trained end-to-end on prior object reconstructions to determine a geometry of an object depicted in digital images and to determine illumination parameters to re-illuminate a reconstructed virtual object based on the geometry according to a received target illumination direction. Because the two transformer models are trained rather than relying on a slow optimization framework, the transformer models jointly generate a reconstructed virtual object based on a scarce number of images (e.g., 2-8 digital images) in seconds. For instance, the reconstructed virtual object is generated based on 2-8 input images, rather than using a time-consuming setup to capture hundreds of input images involved with the conventional virtual object generation techniques using optimization frameworks.

A reconstruction system begins in this example by receiving an input including digital images that depict an object. For example, the digital images are captured from different angles around the object by a digital camera. The input in this example also includes an environment map that indicates a target illumination direction. The environment map depicts an anticipated virtual environment for positioning a reconstructed virtual object based on the object into a video game, computer-aided design environment, or other virtual environment application. In the environment map, the target illumination direction indicates an origin and angle of illumination for illuminating the reconstructed virtual object in the virtual environment. For example, the target illumination direction indicates an illumination direction for a lamp, sunlight, or other light source depicted in the virtual environment that will affect light, shadow, or glare on the reconstructed virtual object.

The reconstruction system uses a first transformer model that is trained to determine a geometry of the object depicted in the digital images. For example, the geometry of the object includes edges, corners, and faces that contribute to an overall shape of the object.

In addition to the first transformer model, the reconstruction system also uses a second transformer model that is trained to determine illumination parameters based on the target illumination direction for re-illuminating the object. For instance, the second transformer model determines how different parts of the geometry of the object, including the edges, the corners, and the shapes interact with the light from the target illumination direction in the environment map.

The reconstruction system then generates an output including the reconstructed virtual object having the geometry and the illumination parameters, as illuminated from the target illumination direction. The reconstructed virtual object, for instance, is configured to be positioned in the virtual three-dimensional environment indicated by the environment map. Because the reconstructed virtual object has the geometry and the illumination parameters illuminated from the target illumination direction, the reconstructed virtual object is a realistic reconstruction of the object from the digital images in the virtual three-dimensional environment and re-illuminated depending on the target illumination direction.

Generating a re-illuminated reconstruction of an object in this manner overcomes the limitations of conventional virtual object generation techniques that are limited to generating a virtual object using an optimization framework. For example, because the two transformer models are trained rather than relying on a slow optimization framework, the transformer models generate a reconstructed virtual object based on a scarce number of images in seconds, rather than optimizing a virtual object for hours using hundreds of input images. The trained transformer models are also efficient at re-illuminating the reconstructed virtual object, which is not possible using the conventional virtual object generation techniques. For these reasons, generating a re-illuminated reconstruction of an object is faster and more efficient than the conventional virtual object generation techniques.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

FIG. 1 is an illustration of a digital medium environment 100 in an example implementation that is operable to employ techniques and systems for generating a re-illuminated reconstruction of an object described herein. The illustrated digital medium environment 100 includes a computing device 102, which is configurable in a variety of ways.

The computing device 102, for instance, is configurable as a desktop computer, a laptop computer, a mobile device (e.g., assuming a handheld configuration such as a tablet or mobile phone), an augmented reality device, and so forth. Thus, the computing device 102 ranges from full resource devices with substantial memory and processor resources (e.g., personal computers, game consoles) to a low-resource device with limited memory and/or processing resources, e.g., mobile devices. Additionally, although a single computing device 102 is shown, the computing device 102 is also representative of a plurality of different devices, such as multiple servers utilized by a business to perform operations “over the cloud” as described in FIG. 9.

The computing device 102 also includes an image processing system 104. The image processing system 104 is implemented at least partially in hardware of the computing device 102 to process and represent digital content 106, which is illustrated as maintained in storage 108 of the computing device 102. Such processing includes creation of the digital content 106, representation of the digital content 106, modification of the digital content 106, and rendering of the digital content 106 for display in a user interface 110 for output, e.g., by a display device 112. Although illustrated as implemented locally at the computing device 102, functionality of the image processing system 104 is also configurable entirely or partially via functionality available via the network 114, such as part of a web service or “in the cloud.”

The computing device 102 also includes a reconstruction module 116 which is illustrated as incorporated by the image processing system 104 to process the digital content 106. In some examples, the reconstruction module 116 is separate from the image processing system 104 such as in an example in which the reconstruction module 116 is available via the network 114.

The reconstruction module 116 is configured to generate a reconstructed virtual object 118, which is a virtual reconstruction of a real-life object under different illumination conditions. For example, the reconstruction module 116 first receives an input 120 including digital images 122 that depict an object 124. The object 124 in this example is a helmet. The digital images 122 correspond to different views of the object 124 captured by a digital camera from different angles surrounding the object 124. For example, the digital images 122 depict the helmet captured from different points of view.

The input 120 also indicates a target illumination direction 126 for re-illuminating the reconstructed virtual object 118. For example, the target illumination direction 126 is indicated on an environment map 128. In some examples, the environment map 128 is a three-dimensional map indicating types of light sources and illumination directions for the light sources in a designed virtual three-dimensional environment. The environment map 128 is also based on a real-life environment in some examples, including light sources modeled after real-life illumination directions for re-illuminating the reconstructed virtual object 118. In this example, the environment map 128 indicates a position of the sun, which is the target illumination direction 126 from which the helmet is to be re-illuminated.

After receiving the digital images 122 and the target illumination direction 126, the reconstruction module 116 uses a machine learning model to determine a geometry of the object 124 and to determine illumination parameters that correspond to the target illumination direction 126 indicated by the environment map 128. In some examples, the machine learning model includes a first transformer model and a second transformer model that are trained end-to-end on virtual object reconstructions based on input images. The first transformer model, for instance, determines the geometry of the object 124, and the second transformer model determines the illumination parameters that correspond to the target illumination direction 126. The geometry, for instance, is information related to a shape or a form of the object 124, including its edges, sides, faces, and/or curves. The geometry is used to generate the reconstructed virtual object 118 because it is information related to generating a three-dimensional reconstruction from two-dimensional images. The illumination parameters, in contrast, indicate the target illumination direction 126 for re-illuminating the reconstructed virtual object 118. In this example, the target illumination direction 126 indicates an illumination direction that is different than illumination depicted in the digital images 122.

Here, the first transformer model and the second transformer model are trained on images of objects illuminated from multiple known directions to re-illuminate the reconstructed virtual object 118 in a virtual three-dimensional environment. The first transformer model and the second transformer model are described in further detail with respect to FIG. 3 below.

The reconstruction module 116 then generates an output 130 including the reconstructed virtual object 118, further examples of which are described in the following sections and shown in corresponding figures. For example, the reconstructed virtual object 118 is a three-dimensional Gaussian that represents positions of points corresponding to surfaces of the object 124 in a virtual three-dimensional space. In some examples, the reconstruction module 116 also generates reconstructed views 132 of the reconstructed virtual object 118 for display in the user interface 110. The reconstructed views 132, for instance, depict individual views of the reconstructed virtual object 118.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Generating a Re-Illuminated Reconstruction of an Object

FIG. 2 depicts a system 200 in an example implementation showing operation of the reconstruction module 116 of FIG. 1 in greater detail. The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks. In portions of the following discussion, reference is made to FIGS. 1-9.

To begin in this example, a reconstruction module 116 receives an input 120 including digital images 122 that depict an object 124. For example, the object 124 is a physical object captured from different angles in the digital images 122 by a digital camera. The input 120 in this example also includes an environment map 128 that indicates a target illumination direction 126. The environment map 128 depicts an anticipated virtual environment for positioning a reconstructed virtual object 118 based on the object 124. The target illumination direction 126 indicates an origin and angle of illumination for illuminating the reconstructed virtual object 118 in the virtual environment. For example, the target illumination direction 126 indicates an illumination direction for a lamp, sunlight, or other light source depicted in the environment map 128. In some examples, the environment map 128 indicates multiple target illumination directions.

The reconstruction module 116 includes a geometry module 202. The geometry module 202 involves a first transformer model 204 that is trained to determine a geometry 206 of the object 124 depicted in the digital images 122. In some examples, the first transformer model 204 analyzes spatial relationships and patterns within the image using a self-attention mechanism. For example, the digital images 122 are divided into small patches (e.g., 16×16 pixels), which are flattened into a vector and transformed into an embedding. The first transformer model 204 then evaluates the relationships between these patches, calculating attention scores to determine how much each patch influences other patches. This allows the first transformer model 204 to determine the geometry 206 of the object 124, including edges, corners, and shapes.

The reconstruction module 116 also includes a re-illumination module 208. The re-illumination module 208 involves a second transformer model 210 that is trained to determine illumination parameters 212 based on the target illumination direction 126 for re-illuminating the object 124. For instance, the re-illumination module 208 determines how different parts of the geometry 206 of the object 124, including the edges, the corners, and the shapes interact with the light from the target illumination direction 126 in the environment map 128. The re-illumination module 208 then generates the reconstructed virtual object 118 having the geometry 206 and the illumination parameters 212 illuminated from the target illumination direction 126. Additionally, the reconstructed virtual object 118 in this example is a three-dimensional Gaussian and is configured for interaction in the virtual environment, including rotating or viewing the reconstructed virtual object 118 to view regions of the geometry 206 that are unviewable in the digital images 122.

The reconstruction module 116 generates an output 130 including the reconstructed virtual object 118. The reconstructed virtual object 118, for instance, is configured to be positioned in a virtual three-dimensional environment indicated by the environment map 128. Because the reconstructed virtual object 118 has the geometry 206 and the illumination parameters 212 illuminated from the target illumination direction 126, the is a realistic reconstruction of the object 124 from the digital images 122 in the virtual three-dimensional environment and re-illuminated depending on the target illumination direction 126.

FIGS. 3-6 depict stages of generating a re-illuminated reconstruction of an object. In some examples, the stages depicted in these figures are performed in a different order than described below.

FIG. 3 depicts an example 300 of an architecture including a first transformer model and a second transformer model of the reconstruction module. As illustrated, the reconstruction module 116 receives digital images 122 depicting an object 124, as well as an environment map 128. The digital images 122 depict different angles of the object 124, and the environment map 128 indicates a target illumination direction 126 for re-illuminating the object 124.

The reconstruction module 116 includes a first transformer model 204 and a second transformer model 210 that are trained jointly end-to-end, which includes a diffusion process to re-illuminate the object 124 depicted in the digital images 122. During inference, geometry tokens 302 are extracted from the digital images 122, which are sparse in number (e.g., 2-8 images), which indicate geometry parameters for the reconstructed virtual object 118, which are per-pixel three-dimensional Gaussians (3DGS).

Noise is injected into re-illuminated views of the object 124 based on the digital images 122 to produce noisy re-illuminated views 304. The noisy re-illuminated views 304, the environment map 128, and a diffusion timestamp 306 indicating how many denoising loops are input as input tokens 308 into the second transformer model 210. The second transformer model 210 conditions the input tokens 308 on novel target illumination based on the target illumination direction 126 and the geometry tokens 302 to denoise the re-illuminated views of the object 124. To do this, the second transformer model 210 predicts a 3DGS appearance, then renders the 3DGS appearance (along with 3DGS geometry that remains fixed in the diffusion denoising loop) into the denoised re-illuminated views, output as appearance tokens 310, and dropping discarded output tokens 312. This iterative process produces the re-illuminated 3DGS radiance as a byproduct while denoising the re-illuminated views. The appearance tokens 310 result in a Gaussian appearance 314 and a Gaussian geometry 316, which the reconstruction module 116 uses to generate the reconstructed virtual object 118. In some examples, the reconstruction module 116 generates reconstructed views 132 of the reconstructed virtual object 118, which are then fed through a progressive view denoising loop 318 to further refine the reconstructed virtual object 118 and/or the reconstructed views 132. In this example, the first transformer model 204 and the second transformer model 210 are trained end-to-end to promote scalability.

The first transformer model 204 and the second transformer model 210 predict 3DGS parameters, including the gaussian appearance 314 and the gaussian geometry 316, from the digital images 122. For example, given a set of N of digital images 122 Iᵢ∈ [symbol] , i=1, 2, . . . , N and corresponding camera Plücker rays Pᵢ, GS-LRM concatenates Iᵢ, Pᵢ channel-wise first, then converts the concatenated feature map into tokens using patch size p. The multi-view tokens are then processed by a sequence of L₁ transformer blocks for predicting 3DGS parameters Gᵢⱼ: one 3DGS at each input view pixel location.

$${\{ {T}_{i j} \}}_{j = 1 , 2 , … , Hw / {p}^{2}} = Linear ( {Patchifyy}_{p} ( Concat ( {I}_{i} , {P}_{i} ) ) ) ,$$

$${\{ {T}_{i j} \}}^{0} = \{ {T}_{i j} \} ,$$

$${\{ {T}_{i j} \}}^{l} = {TransformerBlock}^{l} ( {\{ {T}_{i j} \}}^{l - 1} ) ,$$

$$l = 1 , 2 , … , {L}_{1} ,$$

$$\{ {G}_{i j} \} = Linear ( {\{ {T}_{i j} \}}^{{L}_{1}} ) .$$

In some examples, the reconstruction module 116 removes source illumination from the digital images 122 and re-illuminates the object 124 under target illumination indicated by the target illumination direction 126. To increase re-illumination quality, the reconstruction module 116 generates a re-illuminated 3DGS appearance under novel illumination. The reconstruction module 116 uses the first transformer model 204 and the second transformer model 210 to perform diffusion, in which a three-dimensional representation is used as a bottleneck. Additionally, the second transformer model 210 is conditioned on the novel target illumination and the geometry 206 of the object 124. The second transformer model 210 includes a re-illuminated view denoiser that uses an x₀ prediction objective at each denoising step to output the denoised re-illuminated views by predicting and then rendering the reconstructed virtual object 118.

To predict the 3DGS geometry parameters

$$\{ {G}_{i j}^{g e o m} \} ,$$

the reconstruction module 116 uses the above approach to the GS-LRM and also obtains the last transformer block's output

$$\{ {T}_{i j}^{g e o m} \}$$

of the geometry network to use as input to the re-illuminated view denoiser. To produce the re-illuminated 3DGS appearance under the target illumination direction 126, the reconstruction module 116 then concatenates tokens corresponding to the noisy re-illuminated views 304, the environment map 128, the diffusion timestamp 306, and the geometry tokens 302, passing them through a second transformer stack with L₂ layers. The process is described as follows:

$${\{ {T}_{i}^{all} \}}^{0} = {\{ {T}_{i j}^{noised - re - illuminated - views} \}}^{{L}_{1}} ⊕ \{ {T}_{i j}^{illumination} \} ⊕ \{ {T}_{i j}^{g e o m} \} ⊕ \{ {T}^{timestep} \} \} ,$$

$${\{ {T}_{i}^{all} \}}^{l} = {TransformerBlock}^{{L}_{1} + l} ( {\{ {T}_{i}^{all} \}}^{l - 1} ) ,$$

$$l = 1 , 2 , … , {L}_{2} ,$$

The appearance tokens 310

$${\{ {T}_{i j}^{g e o m} \}}^{{L}_{2}}$$

are used to decode the appearance parameters of the reconstructed virtual object 118, including the gaussian appearance 314 and the gaussian geometry 316, while the other tokens, e.g.,

$${\{ {T}_{i j}^{noised - re - illuminated - views} \}}^{{L}_{2}}$$

are discarded on the output end. In detail, the 3DGS spherical harmonics (SH) coefficients are predicted via a linear layer:

$$\{ {G}_{i j}^{color} \} = Linear ( {\{ {T}_{i j}^{g e o m} \}}^{{L}_{2}} ) ,$$

where

$${G}_{i j}^{c o l o r} ∈ {ℝ}^{75 {p}^{2}}$$

represents the 4^{th} order SH coefficients for the predicted per-pixel 3DGS in a p×p patch. At each denoising step, the denoised re-illuminated views are output (using x₀ prediction objective) by rendering the predicted 3DGS representation:

$$\{ {I}_{i}^{denoised - re - illuminated - views} \} = Render ( \{ {G}_{i j}^{g e o m} \} , \{ {G}_{i j}^{color} \} )$$

The interleaving of 3DGS appearance prediction and rendering in the re-illuminated view denoising process allows the reconstruction module 116 to generate a re-illuminated 3DGS appearance as a side product during inference time. The 3DGS is output at the final denoising step as the reconstruction module 116 final output: a 3DGS re-illuminated by target illumination.

To improve the ability of networks to ingest HDR environment maps E∈ [symbol] in some examples each E is converted into two feature maps through two different tone mappers: one E₁ emphasizing dark regions and one E₂ for bright regions. E₁ and E₂ are then concatenated with the ray direction D, creating a 9-channel feature for each environment map pixel. The reconstruction module 116 then patchifies it into illumination tokens,

$${\{ {T}_{ij}^{illumination} \}}_{j = 1 , 2 , … , {H}_{e} {W}_{e} / {p}_{e}^{2}} ,$$

with a multilayer perceptron (MLP).

In a given training iteration, a sparse set of input images (e.g., 2-8 input images) are sampled for an object under a random illumination and another set of images of the object under different illumination (along with its ground truth environment map). The input posed images are first passed through the geometry transformer to extract object geometry features. Re-illumination diffusion is then performed with the x₀ prediction objective; the denoiser is a transformer network translating predicted 3DGS geometry features into 3DGS appearance features, conditioning on the sampled novel illumination and noised multi-view images under this novel illumination (along with diffusion timestep). The reconstruction module 116 applies [symbol] and perceptual loss to the renderings at both the diffusion viewpoints and another two novel viewpoints in the novel illumination. The deterministic geometry predictor and probabilistic re-illuminated view denoiser are trained jointly end-to-end from scratch.

At inference time, the reconstruction module 116 first reconstructs a 3DGS geometry from the user-provided sparse images. Then the reconstruction module 116 samples a re-illuminated radiance in the form of 3DGS spherical harmonics given a target illumination. The re-illuminated radiance is implicitly generated by sampling the re-illuminated-view diffusion model. Because the denoised re-illuminated views are rendered from the 3DGS geometry and predicted re-illuminated radiance at each denoising step, the re-illuminated-view denoising process also results in a chain of generated re-illuminated radiances.

In this example, the model includes 24 layers of transformer blocks for the geometry reconstruction stage and an additional 8 layers for the appearance diffusion (denoising) stage, with a hidden dimension of 1024 for the transformers and 4096 for the MLPs, totaling approximately 0.4 billion trainable parameters. Input images and environment maps are tokenized using an 8×8 patch size, while denoising views are tokenized with a 16×16 patch size to optimize computational efficiency. Tokenization involves a reshape operation followed by a linear layer, with separate weights for the input and target image tokenizers. The diffusion timestep embedding is processed via an MLP and is appended to the input token set to the diffusion transformer.

The initial training phase employs four input views, four target denoising views (under target illumination, used for computing the diffusion loss), and two additional supervision views (under target illumination), at a resolution of 256×256, with the environment map set to 128×256. The model is trained with a batch size of 512 for 80 K iterations, introducing the perceptual loss after the first 5 K iterations to enhance training stability. Following this pretraining at the 256-resolution, the reconstruction module 116 fine-tunes the model for a larger context by increasing to six input views and six denoising target views at a higher resolution of 512×512. This fine-tuning expands the context window to up to 31 K tokens. For diffusion training, the reconstruction module 116 discretizes the noise into 1,000 timesteps, with a variance schedule that linearly increases from 0.00085 to 0.0120. To enable classifier-free guidance, environment map tokens are randomly masked to zero with a probability of 0.1 during training.

FIG. 4 depicts an example 400 of receiving an input including digital images. As illustrated, the reconstruction module 116 receives an input 120 including digital images 122 that depict an object 124. In this example, the object 124 is a helmet that is a real-life object depicted in the digital images 122. The digital images 122 are captured, for instance, by positioning a digital camera at different angles around a perimeter of the object 124 and capturing the object 124 from different points of view. In other examples, the object 124 is a virtually-generated object, or the digital images 122 depict views of a partial reconstructed virtual object.

The input 120 in this example also includes an environment map 128 that indicates a target illumination direction 126. The environment map 128 includes an image used in computer graphics to simulate the appearance of a surrounding environment reflected on the surface of the object 124. By simulating how a surface of the object 124 reflects its surroundings, the environment map 128 enhances the realism of materials including metal, glass, or other reflective or semi-reflective materials. The environment map 128 is also used for image-based illumination, where the environment map 128 provides illumination information to illuminate the scene. For example, the environment map 128 depicts an anticipated virtual environment for positioning a reconstructed virtual object 118 based on the object 124. The target illumination direction 126 indicates an origin and angle of illumination for illuminating the reconstructed virtual object 118 in the virtual environment. For example, the target illumination direction 126 indicates an illumination direction for a lamp, sunlight, or other light source depicted in the environment map 128. In some examples, the environment map 128 indicates multiple target illumination directions.

As illustrated in this example, the object 124 depicted in the digital images 122 is illuminated from source illumination at an initial illumination direction 402. However, the initial illumination direction 402 is intended to be replaced by the target illumination direction 126 indicated in the environment map 128. For instance, the initial illumination direction 402 is directed toward the front of the helmet, as depicted in the digital images 122. The environment map 128, in contrast, indicates a target illumination direction 126 that illuminates the helmet from the side when the reconstructed virtual object 118 of the helmet is incorporated into the scene indicated by the environment map 128.

FIG. 5 depicts an example 500 of determining a geometry based on the digital images. FIG. 5 is a continuation of the example described in FIG. 4. After the reconstructed virtual object 118 receives the input 120 including the digital images 122 depicting an object 124, the reconstruction module 116 employs a geometry module 202 to determine a geometry 206 of the object 124.

The geometry module 202 involves a first transformer model 204 that is trained to determine a geometry 206 of the object 124 depicted in the digital images 122. In some examples, the first transformer model 204 analyzes spatial relationships and patterns within the image using a self-attention mechanism. For example, the digital images 122 are divided into patches, which are flattened into a vector and transformed into an embedding. The first transformer model 204 then evaluates the relationships between these patches, calculating attention scores to determine how much each patch influences other patches. This allows the first transformer model 204 to determine the geometry 206 of the object 124, including edges, corners, and shapes.

The geometry 206 includes information that is usable to render the object 124 in a virtual three-dimensional environment as a three-dimensional Gaussian. The three-dimensional Gaussian, for instance, is a mathematical function that represents a Gaussian (or normal) distribution in three-dimensional space. It is an extension of a one-dimensional Gaussian function, which is used to describe probabilities or physical phenomena. In some examples, the three-dimensional Gaussian is a point cloud, indicating three-dimensional locations in space for placement of points that form surfaces, edges, corners, curves, or other physical features of the object 124 in the form of the reconstructed virtual object 118. In this example, the geometry 206 identifies information related to a shape of the object 124, while color information related to re-illuminating the object 124 in the form of the reconstructed virtual object 118, including the illumination parameters 212, is described in relation to FIG. 6 below.

FIG. 6 depicts an example 600 of determining illumination parameters for generating the re-illuminated reconstruction of the object. FIG. 6 is a continuation of the example described in FIG. 5. After the geometry module 202 determines the geometry of the object 124, the reconstruction module 116 employs a re-illumination module 208 to determine illumination parameters 212 for the reconstructed virtual object 118.

The re-illumination module 208 involves a second transformer model 210 that is trained on prior virtual object reconstructions to determine illumination parameters 212 based on the target illumination direction 126 for re-illuminating the object 124. In some examples, the first transformer model 204 and the second transformer model 210 are jointly trained on a dataset that contains synthetic renderings and real-world captured data related to virtual object reconstructions.

For instance, the re-illumination module 208 determines how different parts of the geometry 206 of the object 124, including the edges, the corners, and the shapes interact with the light from the target illumination direction 126 in the environment map 128. During a denoising process, the second transformer model 210 generates appearance tokens 310, which correlate to a Gaussian appearance 314 and a Gaussian geometry 316. The second transformer model 210 then generates the reconstructed virtual object 118 based on the Gaussian appearance 314 and the Gaussian geometry 316. For example, the reconstructed virtual object 118 has the geometry 206 of the object 124 depicted in the digital images 122, while illuminated from the target illumination direction 126 specified by the illumination parameters 212. As illustrated in this example, the reconstructed virtual object 118 of the helmet is now illuminated from the side, as indicated by the environment map 128.

The reconstructed virtual object 118 in this example is configured for interaction in the virtual environment, including rotating or viewing the reconstructed virtual object 118 to view regions of the geometry 206 that are unviewable in the digital images 122. For instance, because the reconstructed virtual object 118 illustrates a 360° view of the object 124, the reconstructed virtual object 118 is capable of being viewed from multiple viewpoints.

The reconstruction module 116 generates an output 130 including the reconstructed virtual object 118. The reconstructed virtual object 118, for instance, is configured to be positioned in a virtual three-dimensional environment indicated by the environment map 128. Because the reconstructed virtual object 118 has the geometry 206 and the illumination parameters 212 illuminated from the target illumination direction 126, the is a realistic reconstruction of the object 124 from the digital images 122 in the virtual three-dimensional environment and re-illuminated depending on the target illumination direction 126.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-6.

FIG. 7 depicts a procedure 700 in an example implementation of generating a re-illuminated reconstruction of an object. At block 702 digital images 122 are received depicting an object 124 from different angles and a selection of an illumination direction for virtually illuminating the object 124. In some examples, the selection of the illumination direction is indicated by an environment map 128 specifying a type of illumination for virtually illuminating the object 124. Additionally, in some examples the different angles represent known camera poses relative to the object 124.

At block 704, a geometry 206 of the object is determined using a machine learning model based on the digital images. In some examples, the machine learning model includes a first transformer model 204 trained on prior virtual object reconstructions to reconstruct the geometry 206 of the object 124.

At block 706, illumination parameters 212 are determined corresponding to the illumination direction based on the geometry 206 of the object 124. In some examples, determining the illumination parameters 212 is performed using a second transformer model 210 configured to denoise illuminated views of the reconstructed virtual object. For example, the first transformer model 204 and the second transformer model 210 are trained on images of objects illuminated from multiple known directions. In some examples, determining the illumination parameters 212 is further based on initial illumination of the object 124 depicted in the digital images 122.

At block 708, a reconstructed virtual object 118 is rendered that is a virtual representation of the object 124 based on the geometry 206 and illuminated based on the illumination parameters 212. For example, the reconstructed virtual object 118 is configured for positioning in a virtual three-dimensional environment. In some examples, the reconstructed virtual object 118 is a three-dimensional Gaussian.

FIG. 8 depicts a procedure 800 in an additional example implementation of generating a re-illuminated reconstruction of an object. At block 802, digital images 122 are received depicting an object 124 illuminated from a first illumination direction and selection of a second illumination direction for virtually re-illuminating the object 124. In some examples the selection of the second illumination direction is indicated by an environment map 128 specifying a type of illumination for virtually re-illuminating the object 124.

At block 804, a geometry 206 of the object 124 is determined using a first transformer model 204 based on the digital images 122. The geometry 206, for instance, indicates positions of edges, corners, or faces of the object 124 in a three-dimensional space. In some examples, the first transformer model 204 is trained on prior virtual object reconstructions to reconstruct the geometry 206 of the object 124.

At block 806, illumination parameters 212 are determined corresponding to the second illumination direction using a second transformer model 210 based on the geometry 206 of the object 124. In some examples, the second transformer model 210 is configured to denoise re-illuminated views of the reconstructed virtual object 118. For example, the first transformer model 204 and the second transformer model 210 are trained on images of objects illuminated from multiple known directions.

At block 808, a reconstructed virtual object 118 is rendered that is a virtual representation of the object 124 illuminated from the second illumination direction. For example, the reconstructed virtual object 118 is configured for positioning in a virtual three-dimensional environment. In some examples, the reconstructed virtual object 118 is a three-dimensional Gaussian.

### Example System and Device

FIG. 9 illustrates an example system generally at 900 that includes an example computing device 902 that is representative of one or more computing systems and/or devices that implement the various techniques described herein. This is illustrated through inclusion of the reconstruction module 116. The computing device 902 is configurable, for example, as a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices and/or processing systems 904) to implement techniques, modules, and examples described herein.

The techniques described herein are supported by various configurations of the computing device 902 and are not limited to the specific examples of the techniques described herein. This functionality is also implementable through use of a distributed system, such as over a “cloud” 1114 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized when computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

What is claimed is:

1. A method comprising:
receiving, by a processing device, digital images depicting an object from different angles and a selection of an illumination direction for virtually illuminating the object;
determining, by the processing device, a geometry of the object using a machine learning model based on the digital images;
determining, by the processing device, illumination parameters corresponding to the illumination direction based on the geometry of the object; and
rendering, by the processing device, a reconstructed virtual object that is a virtual representation of the object based on the geometry and illuminated based on the illumination parameters.

2. The method of claim 1, wherein the selection of the illumination direction is indicated by an environment map specifying a type of illumination for virtually illuminating the object.

3. The method of claim 1, wherein the reconstructed virtual object is configured for positioning in a virtual three-dimensional environment.

4. The method of claim 1, wherein the reconstructed virtual object is a three-dimensional Gaussian.

5. The method of claim 1, wherein the machine learning model includes a first transformer model trained on prior virtual object reconstructions to reconstruct the geometry of the object.

6. The method of claim 5, wherein the determining the illumination parameters is performed using a second transformer model configured to denoise illuminated views of the reconstructed virtual object.

7. The method of claim 6, wherein the first transformer model and the second transformer model are trained on images of objects illuminated from multiple known directions.

8. The method of claim 1, wherein the different angles represent known camera poses relative to the object.

9. The method of claim 1, wherein the determining the illumination parameters is further based on initial illumination of the object depicted in the digital images.

10. A non-transitory computer-readable storage medium storing executable instructions, which when executed by a processing device, cause the processing device to perform operations comprising:
receiving digital images depicting an object illuminated from a first illumination direction and selection of a second illumination direction for virtually re-illuminating the object;
determining a geometry of the object using a first transformer model based on the digital images;
determining illumination parameters corresponding to the second illumination direction using a second transformer model based on the geometry of the object; and
rendering a reconstructed virtual object that is a virtual representation of the object illuminated from the second illumination direction.

11. The non-transitory computer-readable storage medium of claim 10, wherein the selection of the second illumination direction is indicated by an environment map specifying a type of illumination for virtually re-illuminating the object.

12. The non-transitory computer-readable storage medium of claim 10, wherein the reconstructed virtual object is configured for positioning in a virtual three-dimensional environment.

13. The non-transitory computer-readable storage medium of claim 10, wherein the reconstructed virtual object is a three-dimensional Gaussian.

14. The non-transitory computer-readable storage medium of claim 10, wherein the first transformer model is trained on prior virtual object reconstructions to reconstruct the geometry of the object.

15. The non-transitory computer-readable storage medium of claim 14, wherein the second transformer model is configured to denoise re-illuminated views of the reconstructed virtual object.

16. The non-transitory computer-readable storage medium of claim 15, wherein the first transformer model and the second transformer model are trained on images of objects illuminated from multiple known directions.

17. A system comprising:
means for receiving digital images depicting an object from different angles and a selection of an illumination direction for virtually illuminating the object;
means for determining a geometry of the object using a machine learning model based on the digital images;
means for determining illumination parameters corresponding to the illumination direction based on the geometry of the object; and
means for rendering a reconstructed virtual object that is a virtual representation of the object based on the geometry and illuminated based on the illumination parameters.

18. The system of claim 17, wherein the selection of the illumination direction is indicated by an environment map specifying a type of illumination for virtually illuminating the object.

19. The system of claim 17, wherein the reconstructed virtual object is configured for positioning in a virtual three-dimensional environment.

20. The system of claim 17, wherein the machine learning model includes a first transformer model trained to reconstruct the geometry of the object and a second transformer model configured to denoise illuminated views of the reconstructed virtual object.
